(19) United States
(12) Patent Application Publication
(10) Pub. No.: US 2020/0412949 A1
(43) Pub. Date: Dec. 31, 2020

(54) DEVICE, SYSTEM, AND METHOD FOR CAPTURING AND PROCESSING DATA FROM A SPACE

(71) Applicant: IniTech Solutions, Inc., Lee's Summit, MO (US)

(72) Inventors: Eric Thogerson, Lake Lotawana, MO (US); Brandee Bower, Lake Lotawana, MO (US); Tracy Ford, Lee's Summit, MO (US)

(21) Appl. No.: 16/910,738

(22) Filed: Jun. 24, 2020

Related U.S. Application Data
(60) Provisional application No. 62/867,155, filed on Jun. 26, 2019.

(51) Int. Cl. H04N 5/232; G06Q 40/08; G01D 21/02; H04N 5/225; H04N 5/445

(52) U.S. Cl. CPC H04N 5/23238; G06Q 40/08; G01D 21/02; H04N 5/2252; G06Q 50/16; H04N 5/23299; H04N 5/2256; H04N 5/44504; H04N 5/2253

(57) ABSTRACT

A system for enabling virtual inspection of a space is provided. The system includes a device for capturing data, a mobile device, a server, and a computing device. The device for capturing data includes one or more data-capturing devices and a processing element configured to receive data from the data-capturing devices and send the data to the mobile device. The mobile device is configured to receive the data and transmit the data to the server. The server and/or the device for capturing data is configured to process the data to generate a digital, three-dimensional rendering of the space and to provide the computing device access to portions of the data and/or the rendering. The computing device is configured to receive the portions of the data and/or the rendering from the server and display the data and/or rendering.

### RELATED APPLICATIONS

The present non-provisional patent application claims priority to U.S. Provisional Patent Application Ser. No. 62/867,155 filed on Jun. 26, 2019, and entitled “DEVICE, SYSTEM, AND METHOD FOR CAPTURING AND PROCESSING DATA FROM A SPACE,” the entirety of which is hereby incorporated by reference into the present non-provisional patent application.

### FIELD OF THE INVENTION

The present invention generally relates to devices, mobile applications, systems, and computer-implemented methods for capturing information about a space to assist with evaluation of the space.

### BACKGROUND

When work needs to be performed on a structure or in a space, such as a residential or commercial property, a professional is often required to inspect the premises. For example, when damage occurs at a residential or commercial property, an insurance claims adjuster or third-party administrator and/or other professionals often must travel to the property and inspect the premises to assess damage. Likewise, consultants, estimators, and/or contractors need to personally inspect the premises of a space for a renovation, repair, and/or the like. This is inefficient, especially for properties in remote locations, and requires such professionals to devote too much time to travel and inspections. However, merely sending a technician to take pictures or videos is often inadequate as such professionals often need to rely on their own expertise and experience to completely inspect the premises.

### BRIEF SUMMARY

Embodiments of the present technology solve the above-described problems and related problems and provide devices, mobile applications, systems, and computer-implemented methods that efficiently capture data from a space and process the data to enable virtual inspection of the space.

One embodiment of the invention is a device for capturing data from a space. The space may include one or more rooms, hallways, and/or areas of a residential and/or commercial property. The device may broadly comprise a housing, a motor operable to rotate the housing about a vertical axis, one or more data-capturing devices, and a processing element supported by the housing.

The processing element is in communication with the data-capturing device and is configured to direct the motor to operate. The processing element is also configured to receive data from the data-capturing devices.

Another embodiment of the invention is a system for capturing and transmitting data from a space. The system may broadly comprise the device described above and a mobile device connected to the device. The mobile device is configured to direct the device to collect data, receive the data from device, and transmit the data to a server.

Another embodiment of the invention is a system for analyzing captured data from a space. The system broadly comprises a server and a first computing device. The server is configured to receive data from a mobile device and/or a data-capturing device. The server is configured to process the data by stitching the data together to form a digital, three-dimensional rendering of the space. The first computing device is in communication with the server and is configured to display portions of the three-dimensional rendering of the space.

Another embodiment of the invention is a computer-implemented method for processing data captured from a space. The method comprises comparing two or more data points of the data; calculating a commonality value of the two or more data points; determining whether the commonality value is within a pre-defined confidence interval; designating the two or more data points as common points if the commonality value is within a pre-defined confidence interval; and stitching the common points together.

Another embodiment of the invention is a computer-implemented method for enabling determining whether there is water damage in a space. The method comprises receiving thermal data from the space, generating a three-dimensional rendering of the space including the thermal data, and displaying the three-dimensional rendering.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of devices, systems, and methods disclosed therein. It should be understood that each Figure depicts an embodiment of a particular aspect of the disclosed devices, systems, and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates an exemplary device for capturing data according to embodiments of the present inventive concept;

FIG. 2A is a front elevated view of a housing of the device;

FIG. 2B is a back elevated view of the housing;

FIG. 2C is a side perspective view of the housing;

FIG. 2D is a lowered perspective view of the housing;

FIG. 3 illustrates various components of the device shown in block schematic form;

FIG. 4 illustrates an exemplary system according to embodiments of the present inventive concept;

FIG. 5 illustrates at least a portion of the steps of an exemplary computer-implemented method for capturing data;

FIG. 6 illustrates at least a portion of the steps of an exemplary computer-implemented method for processing data; and

FIG. 7 illustrates at least a portion of the steps of an exemplary computer-implemented method for enabling detection of water damage.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Embodiments of the present invention may relate to, inter alia, collecting data of space, such as a residential or commercial property; collecting the data using a device having one or more sensors and a mobile device (such as a smart phone, tablet, laptop, etc.); transmitting the data to a remote server (such as a server that is part of a cloud network); analyzing the data via the server to render a digital, two-dimensional and/or three-dimensional rendering of the property; and/or displaying the rendering on a first computing device. Embodiments of the present invention may also incorporate multiple such devices for collecting multiple parts of a space. For example, a first device may be used to collect data about a first floor, and a second device may be used to collect data about a second floor. The devices and/or the remote server may be configured to stitch the data together to form a single two-dimensional and/or three-dimensional rendering of both floors in the space.

Embodiments of the present invention enable accurate and comprehensive remote collection of data relevant to an insurance claim and/or for other inspection/consulting/estimation purposes, thereby providing a more efficient inspection method. Embodiments of the present invention enable comprehensive and relevant data-gathering by unskilled users through thorough and extensive data-capturing. The data may be collected, stored, and/or organized in a structured format so that it may be analyzed by the server, the computing device, and/or used by third-party software, such as Xactimate®. Embodiments of the present invention also provides improved technology for enabling enhanced space as a service (SPaas).

An exemplary data capture process may involve a device having a plurality of data-capturing devices positioned in a space. The space may include one or more rooms, hallways, and/or areas of a residential and/or commercial property. The data may include images and/or video of the space, audio recordings of the space, thermal imaging of the space, humidity in the space, temperature readings in the space, dimensions of the space, GPS coordinates of the space, time stamps associated with such data, and/or other quantified ambient environment data, etc. One of ordinary skill will appreciate that a wide variety of potentially relevant information in a wide variety of forms and media is within the scope of the present invention.

Some or all of the data may be sent to a mobile device and/or the server, as described in more detail elsewhere herein. The server may be configured to receive and store the data and to process the data to form a digital, three-dimensional rendering of the space.

The computing device and/or the mobile device may be in communication with the server. The computing device and/or the mobile device may display the digital, three-dimensional rendering of the space on their displays. The computing device and/or the mobile device may also receive portions of the data in conjunction with the rendering. The data and/or the rendering may be put to a wide variety of uses without departing from the spirit of the present invention.

### Exemplary Device for Capturing Data

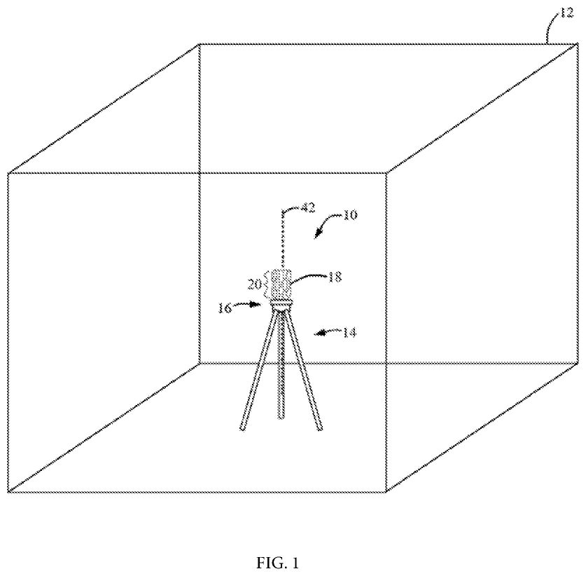

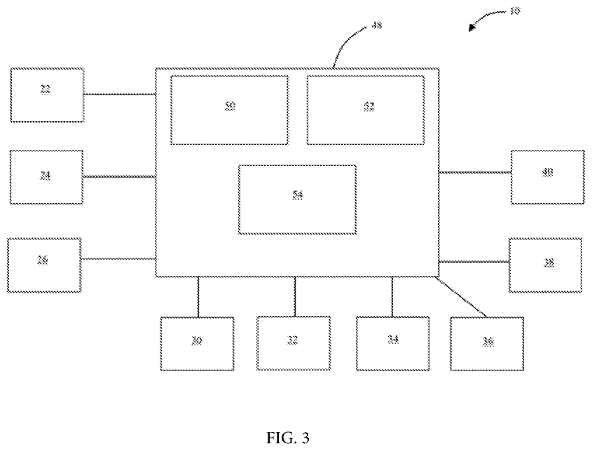

FIG. 1 depicts an exemplary device 10 positioned in a space 12 for capturing data about the space 12. The space 12 may include one or more rooms, hallways, and/or areas of a residential and/or commercial property. The device 10 broadly comprises a stand 14, a platform 16 supported on the stand 14, a housing 18 supported on the platform 16, and a plurality of data-capturing devices 20 supported on the housing 18, a light source 30 supported on the housing 18 (depicted in FIG. 3), a display screen 36 supported by the housing 18 (depicted in FIG. 3), a motor 40 (depicted in FIG. 3) operable to rotate the housing 18 about a vertical axis 42, and a controller 48 (depicted in FIG. 3) configured to control the various components of the device 10. The device 10 may be powered by batteries and/or by plugging into a power source, such as a power outlet.

The stand 14 may be any size and configured to stand on the ground or on a platform, such as a table. The stand 14 may be any support structure and may include any number of legs or frame members without departing from the scope of the present invention. The platform 16 is supported on the stand 14 and is operable to be adjusted so that the platform 16 is level relative to the floor of the space 12 and/or the ground. In some embodiments, the platform 16 may include a latch assembly.

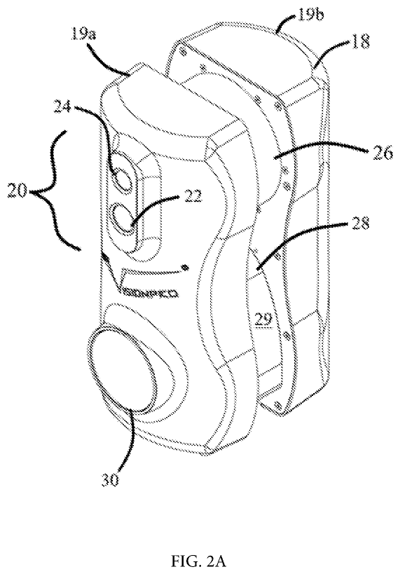

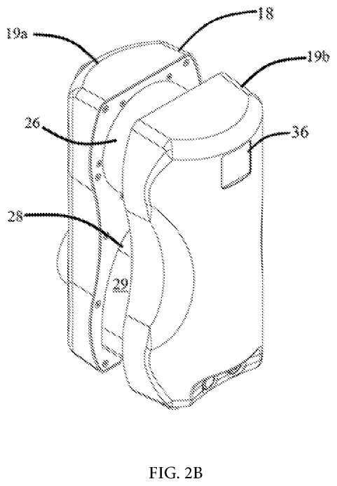

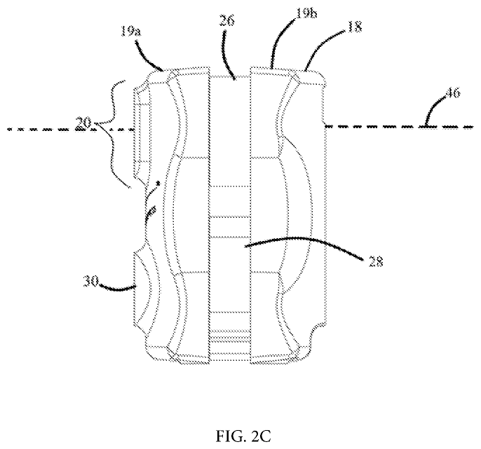

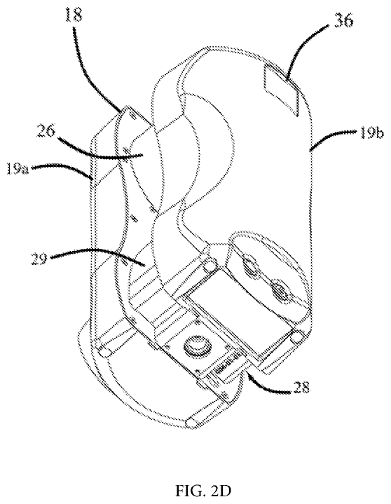

The housing 18 is supported on the platform 16 and houses the various components of the device 10. The housing 18 may be operable to rotate about the vertical axis 42 so that one or more of the data-capturing devices 20 may capture every view of the space 12 from the vantage point of the device 10. The housing 18 may comprise two portions 19a, 19b connected by a middle portion 28, wherein the lidar 26 extends between the two portions 19a, 19b (as shown in FIGS. 2A-D).

The rotation of the housing 18 may be achieved any number of alternative ways without departing from the scope of the present invention. For example, in some embodiments, the device 10 may be configured so that the housing 18 rotates about a horizontal axis without departing from the scope of the present invention. Additionally, the device may be configured so that the housing 18 rotates about any axis to any degree without departing from the scope of the present invention. For example, the device 10 may be configured so that the housing 18 rotates 360°. Additionally or alternatively, the housing 18 may be operable to rotate 180° from a starting point in both directions (clockwise about the horizontal axis and counterclockwise about the horizontal axis). Additionally or alternatively, the housing 18 may be rotated via the motor 40 and gears. In some embodiments, the device 10 does not include a motor 40 and therefore its housing 18 does not rotate while data is collected.

Turning to FIGS. 2A-D, the data-capturing devices 20 are supported by the housing 18 and are configured to capture data representative of attributes and/or features of the space 12. The data-capturing devices 20 may include a camera 22, an infrared (IR) sensor 24, a distance-measuring device 26, a temperature sensor 32, a humidity sensor 34 supported on the housing 18, and an accelerometer 38 (depicted in FIG. 3) housed by the housing 18. The data-capturing devices 20 may include additional or alternative devices/sensors without departing from the scope of the present invention. The data-capturing devices 20 may be configured to capture data while the housing 18 rotates about the vertical axis 42.

The camera 22 is in communication with the controller 48 and is supported on the housing 18. The camera 22 may be configured to capture image data of the space 12, such as images of the walls, ceilings, etc. The camera 22 may be an RGB camera and include a fish-eye lens for panoramic views of the space 12. The camera 22 may be designed for capturing pictures or video. It is foreseen that the device 10 may include any number and type of cameras 22 without departing from the scope of the present invention.

The IR sensor 24 is in communication with the controller 48 and is supported on the housing 18. The IR sensor 24 may be configured to capture data representative of IR light reflected off objects in the space 12, such as walls, ceilings, etc. The IR sensor 24 may be any IR sensor, including a thermal imaging device, a thermal camera, etc. without departing from the scope of the present invention.

The distance-measuring device 26 is in communication with the controller 48 and is supported on the housing 18. The distance-measuring device 26 may be configured to capture data representative of distances from the distance-measuring device 26 to objects in the space 12, such as distances to the walls, ceilings, etc. The distance-measuring device 26 may be a laser radar (lidar) or other device configured to measure a distance without departing from the scope of the present invention. As shown in FIG. 2C, the distance-measuring device 26 is a lidar positioned on the housing 18 so that a middle portion has an unobstructed view substantially 360° around a horizontal axis 46. The distance-measuring device 26 may comprise an internal motor (not shown) operable to spin its laser and sensor (not shown) about the horizontal axis 46 as the housing 18 rotates about the vertical axis 42 (depicted in FIG. 1). This enables the device 10 to capture the dimensions of the space 12. As shown in FIGS. 2A, 2B, and 2D, the middle portion 28 of the housing 18 is recessed back from the surfaces of the two portions 19a, 19b and has sloped sides 29 that enable a larger portion of the 360° about the horizontal axis 46 be unobstructed. This allows the distance-measuring device 26 a larger field of view.

The light source 30 may also be in communication with the controller 48 and supported on the housing 18. The light source 30 is configured to provide light for capturing data, such as images with the camera 22. The light source 30 may be an LED light or other type of light source without departing from the scope of the present invention.

The temperature sensor 32 is supported by the housing 18 and is in communication with the controller 48. The temperature sensor 32 is configured to capture data representative of the temperature of the air in the space 12 and send the data to the controller 48. The humidity sensor 34 is also supported by the housing 18 and is in communication with the controller 48. The humidity sensor 34 is configured to capture data representative of the humidity of the air in the space 12 and send the data to the controller 48.

The display 36 is mounted on the housing 18 and may be in communication with the controller 48, accelerometer 38, the camera 22, and/or the IR sensor 24. The display 36 may be configured to depict images captured by the camera 22 and/or the IR sensor 24. The display 36 may also be configured to display an image representative of how normal the housing 18 is with the floor and/or ground. In other words, it may depict the attitude or orientation of the housing 18. The display 36 may be an OLED, LED, or other type of screen without departing from the scope of the present invention. The display 36 may also be configured to depict the status of various connections and/or power levels. For example, the display 36 may be configured to depict the connection status of the device 10 to the internet, to a cellular network, to a WiFi network, to the remote server/cloud, to the mobile device (via Bluetooth® or NFC), etc. The display 36 may also be configured to depict the power levels of a connected battery and/or whether the device 10 is connected to an external power source.

The accelerometer 38 is housed in the housing 18 and is in communication with the controller 48. The accelerometer 38 is configured to capture data representative of movements of the device 10. For example, the accelerometer 38 may be a three-axis accelerometer that captures data representative of movements of the device 10 on three axes. This data may be used in determining how parallel the platform 16 is with the floor and/or ground. The data from the accelerometer 38 may additionally or alternatively be used to track the location and movements of the device 10 for three-dimensional mapping purposes, as discussed in more detail below. In preferable embodiments, the accelerometer 38 comprises an inertial measurement unit (IMU) comprising one or more accelerometer, one or more gyroscopes, and/or one or more magnetometers. In such embodiments, leveling of the housing 18, stand 14, and/or platform 16 is obviated by data collected by the IMU, which may be used to compensate for detected attitude/orientation of the housing 18. In some embodiments, the accelerometer 38 is incorporated with the controller 48.

The motor 40 is mounted in the housing 18 and is operable to engage the platform 16 in order to rotate the housing 18 about the vertical axis 42. The motor 40 is in communication with the controller 48. In some embodiments, the motor 40 may be mounted on the platform 16 and engage the housing 18 to rotate the housing 18 about the vertical axis 42. The motor 40 may be a stepping motor, a servo motor, or the like.

Turning to FIG. 3, the controller 48 is configured to control the operation of the components of the device 10. The controller 48 may include a communication element 50, a memory element 52, and a processing element 54. The communication element 50 may include signal or data transmitting and receiving circuits, such as antennas, transceivers, amplifiers, filters, mixers, oscillators, digital signal processors (DSPs), and the like. The communication element 50 may establish communication wirelessly by utilizing RF signals and/or data that comply with communication standards such as cellular 2G, 3G, or 4G, IEEE 802.11 standard such as WiFi, IEEE 802.16 standard such as WiMAX, Bluetooth®, Bluetooth® low energy, near-field communication, or the like, or combinations thereof. Alternatively, or in addition, the communication element 50 may establish communication through connectors or couplers that receive metal conductor wires or cables which are compatible with networking technologies such as ethernet. In certain embodiments, the communication element 50 may also couple with optical fiber cables. The communication element 50 may be in communication with or electronically coupled to memory element 52 and/or processing element 54.

The memory element 52 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 52 may be embedded in, or packaged in the same package as, the processing element 54. The memory element 52 may include, or may constitute, a “computer-readable medium.” The memory element 52 may store the instructions, code, code segments, software, firmware, programs, applications, apps, services, daemons, or the like that are executed by the processing element 54. The memory element 52 may also be in electronic communication with the data-capturing devices 20, such as the camera 22, the IR sensor 24, the distance-measuring device 26, the temperature sensor 32, the humidity sensor 34, and/or the accelerometer 38 and may store settings, data, metadata, documents, sound files, photographs, movies, images, databases, and the like.

The processing element 54 may include electronic hardware components such as processors, microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 54 may generally execute, process, or run instructions, code, code segments, software, firmware, programs, applications, apps, processes, services, daemons, or the like. The processing element 54 may also include hardware components such as finite-state machines, sequential and combinational logic, and other electronic circuits that may perform the functions necessary for the operation of the current invention. The processing element 54 may be in communication with the other electronic components through serial or parallel links that include address busses, data busses, control lines, and the like. The processing element may be in electronic communication with the communication element 50, the memory element 52, the camera 22, the IR sensor 24, the distance-measuring device 26, the light source 30, the temperature sensor 32, the humidity sensor 34, the display screen 36, the accelerometer 38, and/or the motor 40.

The processing element 54 may be configured to receive, via wired or wireless communication, a command signal from a mobile device and/or computing device (as described in more detail below), such as through the communication element 50 or other means, to begin a scan of the space 12. The processing element 54 may be configured to direct the display 36 to show connectivity statuses with the mobile device (such as a Bluetooth® connection), the internet (such as a WiFi connection), and/or the server/cloud, etc. The processing element 54 may be configured to receive data from the accelerometer 38 and determine how level the stand 14, platform 16, and/or housing 18 are to the floor/ground. The processing element 54 may be configured to direct the display 36 to show a figure, instructions, or other information, to aid in leveling of the stand 14, platform 16, and/or housing 18. The processing element 54 may be configured to direct the display 36 to depict the status of various connections and/or power levels. For example, the processing element 54 may be configured to direct the display 36 to depict the connection status of the device 10 to the internet, to a cellular network, to a WiFi network, to the remote server/cloud, to the mobile device (via Bluetooth® or NFC), etc. The processing element 54 may be configured to direct the display 36 to depict the power levels of a connected battery and/or whether the device 10 is connected to an external power source.

The processing element 54 may be configured to receive data from the temperature sensor 32 and/or the humidity sensor 34 and store the data in the memory element 52. The processing element 54 may be configured to receive data from the camera 22, the IR sensor 24, and/or the distance-measuring device 26 and store the data in the memory element 52. For example, the processing element 54 may direct the camera 22, the IR sensor 24, and the distance-measuring device 26 to begin capturing data. The processing element 54 may activate the distance-measuring device 26 so that its internal motor (not shown) begins spinning as it collects distance measurements.

The processing element 54 may be configured to direct the motor 40 to rotate the housing 18. The processing element 54 may be configured to direct the rotation of the housing 18 so that it rotates continuously, incrementally, while the data-capturing devices 20 are capturing data, a combination thereof, or via any other algorithm or process steps. The processing element 54 may be configured to capture the data at certain rates, which may be the same or different among the different data-capturing devices 20.

The processing element 54 may be configured to store the data and/or send the data, via wired or wireless communication (including through the communication element 50), to a mobile device, a computing device, and/or a remote server/cloud. The processing element 54 may be configured to associate the different types of data in the memory element 52 according to a time the data was captured, a portion of the space 12, a position of the device 10, etc. as well as store the data with corresponding metadata, such as timestamps indicating when the data was captured, geographic position information of the device 10, source information (such as which device 10 when multiple devices 10 are used in the space 12), where the device 10 was located in the space 12 when the data was captured, the orientation of the housing 18 when the data was captured, etc.

The processing element 54 may be configured to process the data. For example, the processing element 54 may be configured to calculate the dimensions of rooms, halls, etc. of the space 12, and the dimensions of the space 12 itself. The processing element 54 may be configured to calculate the dimensions based on, at least in part, the data from the distance-measuring device 26. For example, a first distance from the distance-measuring device 26 to a first wall may be measured by the distance-measuring device 26 at a first orientation of the housing 18. A second distance from the distance-measuring device 26 to a second wall, which is opposite to the first wall, may be measured by the distance-measuring device 26 at a second orientation of the housing 18 that is 180° from the first orientation. The first distance and the second distance may be added to determine a length of the room.

The processing element 54 may also be configured to implement High Dynamic Range (HDR) image processing. The processing element 54 may be configured to capture several images at the same orientation of the housing 18 while, for example, varying the exposure of the camera 22. The processing element 54 may be configured to stack the images on one another and flatten the images into one image where the best exposed sections of each image are preserved. This results in a better exposed image especially when there are very bright and very dark spots.

The processing element 54 may be configured to stitch the data together to form a virtual representation of the space 12, such as a digital, navigable, two-dimensional and/or three-dimensional rendering of the space 12. The processing element 54 may be configured to use an algorithm that matches common data points from the data captured by one or more of the data-capturing devices 20 as reference points to determine how one or more rooms and/or areas in the space 12 are positioned relative to each other.

For example, the processing element 54 may be configured to designate data points as common data points using statistical analysis: two or more data points may be compared to determine a commonality value. If the commonality value is within a confidence interval, then the data points are designated as common points and are stitched together. The data points may be any of the types of data captured when scanning including a portion of an image captured by the camera 22, a point cloud scanned by the distance-measuring device 26, or a thermal image captured by the IR sensor 24. The stitching algorithm may include image processing to find matching images in different scans to determine common data points. The stitching algorithm may also include stitching adjacent rooms together. For example, an object may be viewable from two perspectives in two adjacent rooms (such as a portion of a doorway between the two rooms) and may be captured by the device 10 during two different scans performed in the two adjacent rooms. The processing element 54 may be configured to designate the images of the object from the different scans as common data points and stitch the two rooms together as adjacent rooms in the rendering. The processing element 54 may also be configured to generate a rendering with multiple layers and/or overlays of data, such as, for example, a rendering having a first image layer and a second layer showing the thermal imaging.

The processing element 54 may also be configured to determine whether there was water damage by comparing thermal image data captured by the IR sensor 24 and/or the temperature data captured by the temperature sensor 32. The processing element 54 may be configured to compare the thermal imaging of objects in the space 12 captured by the IR sensor 24 to determine any relative differences. The processing element 54 may additionally incorporate the temperature data captured by the temperature sensor 32 to determine relative differences. If a difference is determined above a certain threshold, such as thermal image data indicating that a wall has a lower temperature than the temperature captured by the temperature sensor 32, then the processing element 54 may be configured to provide a notification on the display 36 and/or send a notification to the mobile device and/or the server/cloud that indicate there is potential water damage.

In use, the device 10 is placed in the space 12 for data capturing. A mobile device may be used to direct the device 10 to begin capturing data. The controller 48 of the device 10 may be configured to determine whether the platform 16, housing 18, and/or stand 14 is level. The controller 48 may be configured to display information on the display 36 indicating whether the stand 14, platform 16, and/or housing 18 is level and/or how it should be oriented to make it level, if necessary. The display 36

The controller 48 may instruct one or more of the data-capturing devices 20 to begin capturing data. The controller 48 may determine via one or more of the data-capturing devices 20, such as the camera 22, whether additional light is needed and therefore activate the light source 30. The controller 48 may additionally direct the motor 40 to activate in order to rotate the housing 18 about the vertical axis 42. The controller 48 may also display some of the data, such as an image, temperature, humidity, thermal image, etc. on the display 36. The device 10 may transmit the captured data to the mobile device or a remote device, such as a server. The data transmission may occur while the data is being captured, immediately after the data has been captured, and/or at another time.

Once the data is captured at one position in the space 12, the device 10 may be moved to another position within the space 12, such as to an adjacent room, hallway, doorway, or the like. The device 10 may then capture data in that other space and process it and/or transmit the data to the mobile device.

The device 10 may include additional or less features, functions, and/or components, including those described elsewhere herein, without departing from the scope of the present invention. Additionally, multiple devices 10 may be used in a single space 12 to capture data of the space 12. For example, a first device 10 may be used to collect data about a first floor, and a second device 10 may be used to collect data about a second floor. The devices 10 and/or the remote server may be configured to stitch the data together to form a single two-dimensional and/or three-dimensional rendering of both floors in the space 12.

### Exemplary System for Data Collection and Processing

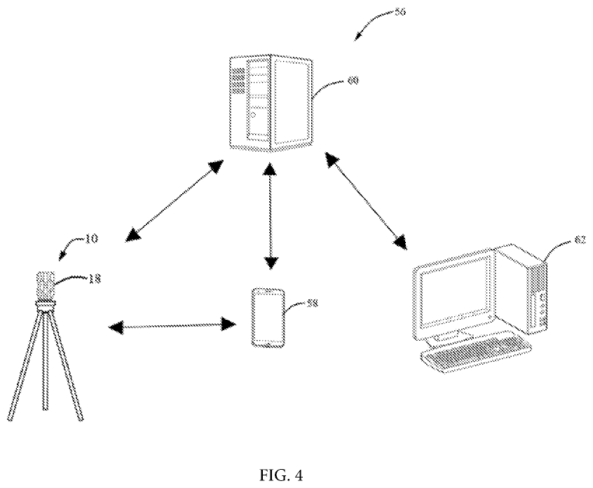

FIG. 4 depicts an exemplary system 56 for capturing, transmitting, processing, and displaying data. The system 56 broadly comprises the device 10, a mobile device 58, a remote server 60, and a first computing device 62. The device 10 is described above and may be in communication with the mobile device 58, the server 60, and/or first computing device 62. The device 10 may be in wired or wireless communication with the mobile device 58, including direct communication and/or communication via a communication network, Bluetooth®, the internet, a cellular network, etc. The device 10 may be configured to receive commands from the mobile device 58 to initiate and perform a data-capturing scan of one or more rooms and/or areas in the space 12. The device 10 may capture the data and send the data to the mobile device 58. The device 10 may also process the data as described above. In some embodiments, the device 10 may send the data to the server 60, depending on the amount of data and/or other factors or settings.

The mobile device 58 is configured to communicate with the device 10 and/or the server 60. The communication may include direct communication and/or communication via a communication network, the internet, a Bluetooth® connection, a cellular network, etc. The mobile device 58 may be a smartphone, tablet, laptop computer, or the like, and may be configured to receive information from a user, send commands to the device 10, receive data from the device 10, and transmit the data to the server 60 and/or the computing device 62. The mobile device 58 may also be configured to view the data, such as a rendering of the space 12. The mobile device 58 may have stored thereon a mobile application configured to operate the device 10. The mobile device 58 may additionally or alternatively use an internet browser to navigate to a web page that may be used to operate the device 10.

The server 60 is configured to send and/or receive the data (such as through the internet or other connection), process the data, and/or store the data. The server 60 may be embodied by one or more application servers, database servers, file servers, mail servers, print servers, web servers, cloud computers, or the like, or combinations thereof. Furthermore, the server 60 may include a plurality of servers, virtual servers, or combinations thereof. For example, the server 60 may comprise a cloud network of cloud servers.

The server 60 may be configured to include or execute computer programs and software such as file storage applications, database applications, email or messaging applications, web server applications, cloud applications, or the like, in addition to and/or in conjunction with the computer program and/or software described elsewhere herein.

The server 60 may include a communication element, a memory element, and a processing element (not shown). The communication element generally allows communication with external systems or devices (such as the mobile device 58, the device 10, and/or the computing device 62) and/or between one or more individual servers. The communication element may include signal or data transmitting and receiving circuits, such as antennas, transceivers, amplifiers, filters, mixers, oscillators, digital signal processors (DSPs), and the like. The communication element may establish communication wirelessly by utilizing RF signals and/or data that comply with communication standards such as cellular 2G, 3G, 4G, 5G, or LTE, IEEE 802.11 standard such as WiFi, IEEE 802.16 standard such as WiMAX, Bluetooth®, or combinations thereof. Alternatively, or in addition, the communication element may establish communication through connectors or couplers that receive metal conductor wires or cables which are compatible with networking technologies such as ethernet. In certain embodiments, the communication element may also couple with optical fiber cables. The communication element may be in communication with or electronically coupled to memory element and/or processing element.

The memory element may include data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, USB ports, or the like, or combinations thereof. The memory element may include, or may constitute, a “computer-readable medium.” The memory element may store the instructions, code, code segments, software, firmware, programs, applications, apps, services, daemons, or the like that are executed by the processing element. The memory element may also store settings, data, documents, sound files, photographs, movies, images, databases, and the like.

The processing element may include processors, microprocessors, microcontrollers, DSPs, field-programmable gate arrays (FPGAs), analog and/or digital application-specific integrated circuits (ASICs), or the like, or combinations thereof. The processing element may generally execute, process, or run instructions, code, code segments, software, firmware, programs, applications, apps, processes, services, daemons, or the like. The processing element may also include hardware components, such as finite-state machines, sequential and combinational logic, and other electronic circuits that may perform the functions necessary for the operation of embodiments of the current inventive concept. The processing element may be in communication with the other electronic components through serial or parallel links that include address busses, data busses, control lines, and the like.

The server 60 may be configured to send and/or receive the data from the device 10 and/or the mobile device 58. The server 60 may also be configured to store the data. The server 60 may receive the data in a structured format, and/or the server 60 may be configured to structure the data. The data may be received with various metadata, such as timestamps indicating when the data was captured, geographic position information, source information (such as which device 10 if there were a plurality of devices 10 to scan the space 12), where the device 10 was located in the space 12 when the data was captured, the orientation of the housing 18 when the data was captured, etc. The server 60 may be configured to calculate the dimensions of the space 12 and/or its rooms, hallways, or other areas based on, at least in part, the data from the distance-measuring device 26.

The server 60 may be configured to select multiple images that were captured at the same position and orientation and stack the images on one another. The server 60 may be configured to flatten the images into one image where the best exposed sections of each image are preserved.

Depending on the scope of the project, such as the size and/or number of rooms in the space 12, and/or other factors, the server 60 may be configured to process portions of the data in order to generate the digital, three-dimensional rendering of the space 12. For example, the server 60 may be configured to determine adjacent images of the space 12 based on the metadata of the images, associated dimensional data (such as from the distance-measuring device 16 and/or the accelerometer 38), thermal data, etc. For example, the server 60 may be configured to determine common objects and/or points in the space 12 that were captured by two images via the camera 22. The common objects may then be used as a basis to display the two images adjacent to one another and/or combine the images. Additionally, two thermal images associated (associated via, for example, shared metadata like timestamps, orientation of the housing 18, orientation of the housing 18, etc.) with the adjacent and/or combined images may therefore be made adjacent in the rendering and/or combined. The server 60 may be configured to generate a plurality of layers in the rendering and/or overlay the image data from the camera 22 with the thermal image data from the IR sensor 24.

The server 60 may be configured to use an algorithm that matches common data points from the data captured by one or more of the data-capturing devices 20 as reference points to determine how one or more rooms and/or areas in the space 12 are positioned relative to each other. The server 60 may be configured to designate data points as common data points using statistical analysis: two or more data points may be compared to determine a commonality value. If the commonality value is within a confidence interval, then the data points are designated as common points and are stitched together. The data points may be any of the types of data captured when scanning including an image captured by the camera 22, a point cloud scanned by the distance-measuring device 26, or a thermal image captured by the IR sensor 24. The stitching algorithm may include image processing to find matching images in different scans to determine common data points.

The server 60 may also be configured to determine whether there was water damage by comparing thermal image data captured by the IR sensor 24 and/or the temperature data captured by the temperature sensor 32. The server 60 may be configured to compare the thermal imaging of objects in the space 12 to determine any relative differences. The difference may be determined via thermal image data indicating that a wall in the space 12 has a lower temperature than the rest of the space 12.

The server 60 may also be configured to process and present the data so that when the data is viewed via an internet browser or application by the mobile device 58 and/or computing device 62, various software tools are available to provide navigation and other information. For example, the server 60 may be configured to receive input from the mobile device 58 and/or computing device 62 identifying two or more specific points in a rendering and a request for a distance measurement. The server 60 may be configured to calculate the distance between the two or more points based on the corresponding lidar data for those points. This may be used, for example, to measure a length and/or area of a wall, such as for repair/improvement cost estimations. The server 60 may also be configured to generate vision tags for navigation and/or additional data. The server 60 may be configured to receive selections of one or more objects and/or point clouds and display data related to the objects and/or point clouds. For example, a wall in the rendering may be selected by a user operating the mobile device 58 and/or computing device 62. The server 60 may receive the selection and display thermal data associated with the wall and space 12 and/or a time and date of when the data was captured by the device 10. Additionally, the server 60 may be configured to determine the floors of the space and generate one or more selectable vision tags that provide a direction in which a user may virtually navigate the rendering of the space 12 via the mobile device 58 and/or the computing device 62. In some embodiments, the server 60 may be configured to provide multiple such vision tags extending away from the user's virtual location in the rendering so that the user may virtually navigate a farther distance within the rendering. The server 60 may also be configured to receive a selection of a point cloud and/or an object in the rendering, receive text, and store the text in association with the point cloud. For example, a user may view the rendering via the mobile device 58 and/or the computing device 62, select a point cloud and/or object, and write a comment/note about the object and/or point cloud. The server 60 may be configured to provide additional, fewer, and/or different software tools without departing from the scope of the present invention.

The server 60 may include various access and permission levels of viewing data and/or renderings. Additionally, the server 60 may include security features for allowing only certain users to access certain data/renderings. For example, the server 60 may receive a request to view and/or receive certain data and/or renderings from the computing device 62 to which the server 60 requires the computing device 62 to enter authenticating information, i.e., provide log-in credentials.

The computing device 62 may be in communication with the server 60 and configured to receive and/or view the data from the server 60. The computing device 62 may be a smartphone, tablet, laptop computer, desktop computer, server, etc. In some embodiments, the computing device 62 is in communication with the device 10 and/or the mobile device 58. The computing device 62 may be configured to request access to data and/or the digital, three-dimensional rendering of the space 12. The computing device 62 may be configured to receive the data and/or rendering from the server 60 and/or view the data and/or rendering via an internet browser connected to a web site hosting the data and/or rendering and uses the security protocols listed above.

In use, the device 10 captures the data of the space 12 via one or more data-capturing devices as described above. The space 12 may include one or more rooms of a residential or commercial building, or the like. The device 10 may process the data to form a digital, three-dimensional rendering of the space 12. The device 10 may then send the data and any rendering to the mobile device 58, which may send it to the server 60. Additionally or alternatively, based on factors such as amount of data, wireless connectivity (such as availability of WiFi), power availability (such as battery levels and/or availability of a power outlet), or other factors, the device 10 may send the data and/or the rendering to the server 60 via wireless communication, such as via WiFi and/or a cellular network. In some embodiments, the device 10 may send the data and/or the rendering via wired communication to the mobile device 58 and/or an external memory element, both of which may then be used to transfer the data and/or the rendering to the server 60. Other means of sending the data and/or the rendering to the server 60 may be used without departing from the scope of the present invention.

If the device 10 processes the data, the device 10 may determine whether there is an indication of water damage and send a notification to the mobile device 58 and/or present a notification on its display 36.

The server 60 receives the data and/or the rendering from the device 10 and/or the mobile device 58. If the server 60 only receives the data, the server 60 may be configured to process the data to generate a digital, three-dimensional rendering. For example, in some embodiments, the server 60 may provide software as a service to process data it receives to generate a digital, three-dimensional rendering so that an authorized user can then access the data and/or rendering to virtually inspect the space 12 from the computing device 62.

The system 56 may include additional or less features, functions, and/or components, including those described elsewhere herein, without departing from the scope of the present invention.

### Exemplary Computer-Implemented Method

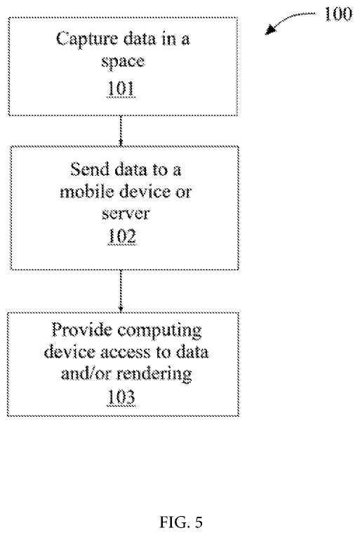

FIG. 5 depicts a listing of steps of an exemplary computer-implemented method 100 for capturing and processing data regarding a space 12. The steps may be performed in the order shown in FIG. 5, or they may be performed in a different order. Furthermore, some steps may be performed concurrently as opposed to sequentially. In addition, some steps may be optional.

The computer-implemented method 100 is described below, for ease of reference, as being executed by exemplary devices and components introduced with the embodiments illustrated in FIGS. 1-4. For example, the steps of the computer-implemented method 100 may be performed by the device 10, the mobile device 58, the server 60, and/or the computing device 62 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 101, data is captured in the space 12. The data may be captured via one or more data-capturing devices 20 of the device 10. The data may be captured and associated with generated metadata, including timestamps indicating when the data was captured, geographic position information, source information (such as which data-capturing devices 20—whether the data was captured by the camera 22, the IR sensor 24, the distance-measuring device 26, the temperature sensor 32, etc.), where the device 10 was located in the space 12 when the data was captured, the orientation of the housing 18 when the data was captured, etc.

This step 101 may include receiving, via wired or wireless communication, a command signal from the mobile device 58 and/or the computing device 62, such as through the communication element 50 or other means, to begin a scan of the space 12. Data from the accelerometer 38 may be received, and how level the platform 16 is to the floor/ground may be determined. The display 36 may be directed to show a figure, instructions, or other information based on the data from the accelerometer 38 to aid in leveling the platform 16. Data may be received from the temperature sensor 32 and/or the humidity sensor 34 and stored in the memory element 52. The data may be received from the camera 22, the IR sensor 24, and/or the distance-measuring device 26 and stored in the memory element 52.

This step 101 may include directing the motor 40 to rotate the housing 18. The motor 40 may be directed to rotate so that it rotates continuously, incrementally, while one or more of the data-capturing devices 20 are capturing data, a combination thereof, or via any other algorithm or process steps. The data may be captured at certain rates, which may be the same or different among the different data-capturing devices 20. The data may be stored and/or sent, via wired or wireless communication (including through the communication element 50), to the mobile device 58, the computing device 62, and/or the server 60. The different types of data may be associated in the memory element 52 according to the time the data was captured, a portion of the space 12, a position of the device 10, etc. and/or stored according to its corresponding metadata, such as timestamps indicating when the data was captured, geographic position information of the device 10, source information (such as which of the data-capturing devices 20 captured the data), where the device 10 was located in the space 12 when the data was captured, the orientation of the housing 18 when the data was captured, etc.

This step 101 may include processing the data. The data may be processed via the processing element 54 of the device 10. A digital, three-dimensional rendering of the space 12 may be generated using the data. For example, the adjacent and/or overlapping images of the space 12 may be determined based on the metadata of the images, associated dimensional data (such as from the distance-measuring device 26 and/or the accelerometer 38), thermal data, etc. Additionally, common objects and/or points in the space 12 that were captured by two images via the camera 22 may be detected. The common objects may then be used as a basis to display the two images adjacent to one another and/or combine portions of the images. Additionally, two thermal images associated with the adjacent and/or combined images may therefore be made adjacent in the rendering and/or combined. Each thermal image may be associated with its corresponding image data via, for example, shared metadata, such as timestamps, orientations of the housing 18, etc. A plurality of layers in the rendering may be generated and/or the image data from the camera 22 may be overlaid with the thermal image data from the IR sensor 24.

This step 101 may include selecting and stacking multiple images that were captured at the same position and orientation. The images may be flattened into one image in which the best-exposed sections of each image are preserved.

This step 101 may include executing an algorithm that matches common data points from the data captured by one or more of the data-capturing devices 20. The common data points may be used as reference points to determine how one or more rooms and/or areas are positioned relative to one another in the space 12. Data points may be designated as common data points using statistical analysis. For example, two or more data points may be compared to determine a commonality value. If the commonality value is within a confidence interval, then the data points are designated as common points and are stitched together in the rendering. The data points may be any of the types of data captured when scanning, including an image captured by the camera 22, a point cloud scanned by the distance-measuring device 26, and/or a thermal image captured by the IR sensor 24. The stitching algorithm may include image processing to find matching images in different scans to determine common data points. For example, a sticker may have been strategically positioned (such as on portion of a doorway) so that image data captured in two different rooms will detect the sticker. The images of the sticker from the different scans may be detected and designated as common data points.

This step 101 may also include determining whether there was water damage. Thermal image data captured by the IR sensor 24 and the temperature data captured by the temperature sensor 32 may be compared. Additionally or alternatively, the thermal imaging of two or more objects in the space 12 may be compared to determine any relative differences. The differences may be determined via thermal image data indicating that a first object in the space 12 has a lower temperature than the rest of the space 12 and/or a second nearby object in the space 12.

Referring to step 102, the data is sent to the mobile device 58 and/or the server 60. The data may be sent via wired and/or wireless communication. This step 102 may include sending the rendering in addition to, or instead of, the data. The data may be stored in a memory element of the server 60. This step 102 may also include processing the data as described above.

Referring to step 103, portions of the data and/or the rendering may be made accessible to the computing device 62. For example, a request to view the data and/or the rendering may be received. The source of the request may be verified, and the data and/or the rendering may be sent to the computing device 62. Additionally or alternatively, only portions of the rendering and/or data may be sent in the form of tables, images, and/or videos so that the computing device 62 may display the portions of the data and/or rendering requested, yet the entirety of the data and/or rendering remains stored on the server 60.

### Exemplary Computer-Implemented Method for Processing Data

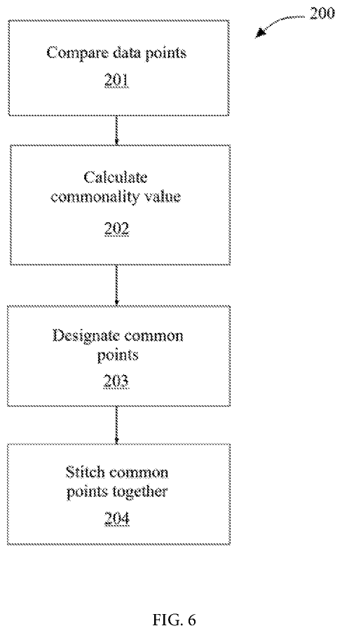

FIG. 6 depicts a listing of steps of an exemplary computer-implemented method 200 for processing data regarding a space 12. The steps may be performed in the order shown in FIG. 6, or they may be performed in a different order. Furthermore, some steps may be performed concurrently as opposed to sequentially. In addition, some steps may be optional.

The computer-implemented method 200 is described below, for ease of reference, as being executed by exemplary devices and components introduced with the embodiments illustrated in FIGS. 1-4. For example, the steps of the computer-implemented method 200 may be performed by the device 10, the mobile device 58, the server 60, and/or the computing device 62 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 201, two or more data points may be compared. The data points may be any of the types of data captured when scanning, including an image captured by the camera 22, a point cloud scanned by the distance-measuring device 26, thermal image captured by the IR sensor 24, and/or data captured by the accelerometer 38 (such as IMU data). Two or more data points may be compared based on image data, thermal data, positional data, orientation data, metadata, IMU data, etc. For example, two images may be compared to find how similar portions of the two images are.

Referring to step 202, a commonality value may be calculated among one or more data points. The commonality value may be based on the degree of similarity between two portions of images, metadata, or any other data captured by the device 10. For example, if two portions of images contain a same object in the space 12, then the commonality value would indicate a strong correlation, such as a high numeric value and/or a low numeric value, depending on a desired rating system.

Referring to step 203, statistical analysis is used to designate common points. For example, if the commonality value of two data points is indicative of portions of images capturing the same object in the space 12, the data points are designated as common points. The commonality value may be determined to be within or outside of a pre-defined confidence interval. If the commonality value is within the confidence interval, indicating that a same object was captured in the two images, then the data points are designated as common points.

Referring to step 204, the common point is stitched together to form a portion of digital, three-dimensional rendering. For example, if a bottom third of a first image and a top third of a second image have one or more common points, the first image and second image may be stitched together so that the top third of the first image and the bottom third of a second image are overlaid.

### Exemplary Computer-Implemented Method for Enabling Detection of Water Damage

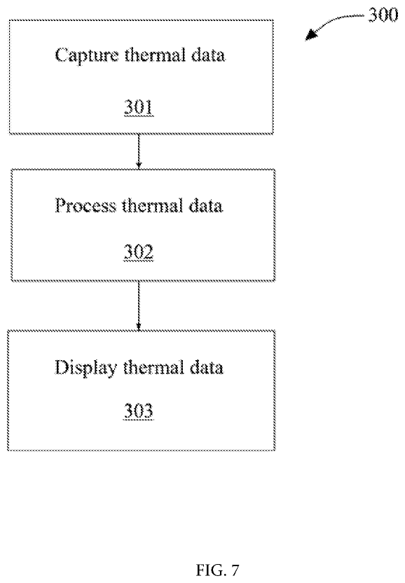

FIG. 7 depicts a listing of steps of an exemplary computer-implemented method 300 for detecting water damage in a space 12. The steps may be performed in the order shown in FIG. 7, or they may be performed in a different order. Furthermore, some steps may be performed concurrently as opposed to sequentially. In addition, some steps may be optional.

The computer-implemented method 300 is described below, for ease of reference, as being executed by exemplary devices and components introduced with the embodiments illustrated in FIGS. 1-4. For example, the steps of the computer-implemented method 300 may be performed by the device 10, the mobile device 58, the server 60, and/or the computing device 62 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 301, thermal data may be captured in the space 12. The thermal data may be captured via an IR sensor 24 of the device 10.

Referring to step 302, the thermal data may be processed to form a digital, two-dimensional and/or three-dimensional rendering. The thermal data may be stitched together as described in the method 200 to form a rendering made of thermal images. Additionally or alternatively, the thermal data may be overlaid on corresponding image data existing on a pre-existing rendering. The thermal data may correspond to image data based on metadata, such as a shared timestamp of the image data and thermal data, shared values representing the orientation of the housing 18, etc.

Referring to step 303, the thermal rendering may then be displayed. The thermal rendering may be displayed on the computing device 62, the mobile device 58, or the like. This enables a user to visually compare the thermal images of adjacent/nearby objects (such as walls, ceilings, cabinets, etc.) in the space 12 to find relative differences. For example, an object having a relatively cooler temperature may be displayed as having a lighter hue, a blue hue, etc., which may be indicative of water damage. Thermal images may also be fused with contrast-edited RGB images or opacity-layered.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth in any subsequent regular utility patent application. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processing elements or processor-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim (s).

Although the invention has been described with reference to the embodiments illustrated in the attached drawing figures, it is noted that equivalents may be employed, and substitutions made herein without departing from the scope of the invention.

1. A device for capturing data from a space, the device comprising:
a housing;
a motor operable to rotate the housing about a vertical axis;
a data-capturing device supported on the housing; and
a processing element in communication with the motor and the data-capturing device and configured to activate the motor and receive data from the data-capturing device.

2. The device of claim 1, wherein the data-capturing device comprises at least one of a camera, a distance-measuring device, an accelerometer, an infrared sensor, a temperature sensor, or a humidity sensor.

3. The device of claim 1, wherein the data-capturing device comprises a camera with at least one of a fish-eye lens or a wide-angle lens to capture panoramic views of the space.

4. The device of claim 1, wherein the processing element is configured to:
compare two or more points of the data;
calculate a commonality value of the two or more points of the data;
determine whether the commonality value is within a pre-defined confidence interval;
designate the two or more points of data as common points if the commonality value is within a pre-defined confidence interval; and
stitch the common points together to form a three-dimensional rendering of the space.

5. The device of claim 1, further comprising a communication element configured to transmit the data to an external device.

6. The device of claim 1, further comprising a light source for emitting lighting into the space.

7. The device of claim 1, further comprising a display configured to depict a portion of the data captured by the data-capturing device.

8. A system for capturing data from a space, the system comprising:
a data-capturing device including—
a housing,
a motor operable to rotate the housing about a vertical axis,
a data-capturing device supported on the housing,
a processing element in communication with the motor and the data-capturing device and configured to activate the motor and to receive data from the data-capturing device, and
a communication element in communication with the processing element and configured to transmit the data; and
a server configured to receive the data.

9. The system of claim 8, wherein the processing element of the data-capturing device is configured to process the data to form a digital, three-dimensional rendering of the space.

10. The system of claim 8, wherein the server is configured to process the data to form a digital, three-dimensional rendering of the space.

11. The system of claim 8, further comprising a mobile device in communication with the communication element of the data-capturing device and the server, the mobile device being configured to receive the data from the data-capturing device and transmit the data to the server.

12. The system of claim 8, further comprising a computing device in communication with the server and configured to receive the data from the server.

13. The device of claim 8, wherein the data-capturing device comprises at least one of a camera, a distance-measuring device, an accelerometer, an infrared sensor, a temperature sensor, or a humidity sensor.

14. The device of claim 8, wherein the data-capturing device comprises a camera with at least one of a fish-eye lens or a wide-angle lens to capture panoramic views of the space.

15. The device of claim 8, wherein the processing element is configured to:
compare two or more points of the data;
calculate a commonality value of the two or more points of the data;
determine whether the commonality value is within a pre-defined confidence interval;
designate the two or more points of data as common points if the commonality value is within a pre-defined confidence interval; and
stitch the common points together to form a three-dimensional rendering of the space.

16. The device of claim 8, further comprising a light source for emitting lighting into the space.

17. The device of claim 8, further comprising a display configured to depict a portion of the data captured by the data-capturing device.

18. A computer-implemented method for processing data to generate a digital, three-dimensional rendering, the method comprising:
comparing two or more data points of the data;
calculating a commonality value of the two or more data points;
determining whether the commonality value is within a pre-defined confidence interval;
designating the two or more data points as common points if the commonality value is within a pre-defined confidence interval; and
stitching the common points together.

19. The computer-implemented method of claim 18, further comprising:
capturing thermal data from the space; and
super-imposing the thermal data onto the digital, three-dimensional rendering of the space; and
analyzing the thermal data for anomalies that could indicate water damage.

20. The computer-implemented method of claim 18, wherein the two or more data points comprise at least one of image data, thermal data, distance measurement data, or orientation data.
